(19) United States
(12) Patent Application Publication
(10) Pub. No.: US 2011/0017153 A1
(43) Pub. Date: Jan. 27, 2011

(54) System for on demand hydrogen production and delivery of hydrogen to an internal combustion engine

(75) Inventors: Joseph Michael Moon, Virginia Beach, VA (US); Joseph E. Leiato, Grafenwoehr (DE); Timothy Iinug Mark Yataman Leiato, Grafenwoehr (DE)

Correspondence Address: Davidson, Davidson & Kappel, LLC, 485 7th Avenue, 14th Floor, New York, NY, 10018, US

(73) Assignee: Green On Demand, LLP (G.O.D.), Virginia Beach, VA (US)

(21) Appl. No.: 12/592,814

(22) Filed: Dec. 3, 2009

Related U.S. Application Data
(60) Provisional application No. 61/271,497, filed on Jul. 22, 2009.

(51) Int. Cl. F02B 43/08

(52) U.S. Cl. 123/3

(57) ABSTRACT

The invention discloses a system for the production of hydrogen from water by electrolysis. A container, defining a first portion for holding a plurality of parallel and plate like anodes and a second portion for holding a plurality of parallel and plate like cathodes. A cover is provided for the first portion with an outlet and an attached duct for oxygen, wherein the duct for oxygen leads to the environment. The cover is provided for the second portion with an outlet and an attached duct for hydrogen, wherein the duct for hydrogen leads to an internal combustion engine. An inlet to the container provides water from a reservoir, so that the level of water is maintained at a constant level within the container.

This claims the benefit of U.S. Patent Application No. 61/271,497, filed on Jul. 22, 2009 and hereby incorporated by reference herein.

### FIELD OF THE INVENTION

The present invention relates a system for providing hydrogen to an internal combustion engine which is surrounded by a body.

### BACKGROUND OF THE INVENTION

The environmental effects of pollution and global warming require an energy source which is easy available and lowers the pollution. There is an ongoing search for another viable, safe and economical source of alternative fuel compared to fossil fuel. Hydrogen is the most abundant element in the universe. On earth 90% of the hydrogen atoms are found in water and consequently water has been vied as the favorite choice for an endlessly and renewable fuel propulsion source.

Electrolysis is the main procedure that is being used to produce hydrogen from water. Each water molecule has two hydrogen atoms and one oxygen atom. Passing an electric current through water, causes the two gases to separate. The oxygen migrates to the positive electrode, the anode and the negative electrode, the cathode, attracts the hydrogen. The resulting process yields twice as much hydrogen as oxygen.

The text book “Fuel From Water”; 12^{th} edition, Copyright © 2008 by Merit Products Inc. Box 6868, Louisville, Ky. 40206; ISBN 978-0-945516-04-0, discloses various concepts to obtain hydrogen from water and the hydrogen is used for example as an energy source for providing power for an internal combustion engine.

U.S. Pat. No. 6,533,919 discloses a method for electrolysis of an aqueous solution of an organic fuel. The electrolyte is a solid-state polymer membrane with anode and cathode catalysts on both surfaces for electro-oxidation and electro-reduction.

In German Patent Application DE 44 43 476 A1, a method is described which provided an internal combustion engine of a vehicle with hydrogen. The vehicle has an electrolysis device for the production of hydrogen and several storage tanks for hydrogen.

U.S. Pat. RE 38,066 discloses an electrolysis apparatus which has a number of membrane electrolysis cells. Each of the cells has a membrane formed on both sides with a contact layer. The apparatus, while it is compact in its design, is also suitable for comparatively high hydrogen production rates and can consequently be used particularly flexibly. A contact plate is respectively arranged on each contact layer. Each of the contact plates is formed, on its surface facing the contact layer assigned to it, with a system of ducts for the transport of water and/or gas.

U.S. Pat. No. 6,726,893 discloses a device and method for separating water into hydrogen and oxygen is disclosed. A first substantially gas impervious solid electron-conducting membrane for selectively passing hydrogen is provided and spaced from a second substantially gas impervious solid electron-conducting membrane for selectively passing oxygen. When steam is passed between the two membranes at disassociation temperatures the hydrogen from the disassociation of steam selectively and continuously passes through the first membrane and oxygen selectively and continuously passes through the second membrane, thereby continuously driving the disassociation of steam producing hydrogen and oxygen.

U.S. Pat. No. 7,536,981 discloses a hydrogen gas generator in the form of a reformer. The reformer is used to produce a reformate gas containing hydrogen and at least one other component for use as a fuel or part of a fuel for a compression engine. The hydrogen containing gas blend or mix is used as one component of a fuel for the engine using hydrogen assisted combustion. The hydrogen containing gas produced as the reformate does not require the non hydrogen components to be removed from the gas prior to introduction to the engine either directly or indirectly. This provides a significant saving in cost as pure hydrogen is no longer required for hydrogen assisted combustion.

The invention, disclosed in U.S. Pat. No. 6,908,699, is a method of generating electrical energy from chemically generated hydrogen and oxygen including the steps of establishing a first reaction compartment, generating hydrogen gas from a reaction of aluminum metal and aqueous alkali solution in the first reaction compartment, establishing a second reaction compartment, generating oxygen gas from a reaction of oxygenated salt, water and a catalyst in the second reaction compartment, fluidly coupling the first reaction compartment to a fuel cell anode, fluidly coupling the second reaction compartment to a fuel cell cathode, and feeding the hydrogen and oxygen gas to a fuel cell to generate electricity.

An electric power generator including a fuel cell is disclosed in U.S. Pat. No. 7,074,509. The fuel cell includes a fuel cell anode and a fuel cell cathode separated by at least one proton exchange membrane and a hydrogen generator operative to provide molecular hydrogen to the fuel cell anode. The hydrogen generator includes a catalyst and employing a water-based fuel including one of salts, bases and acids, as well as at least one of zinc, magnesium, iron and aluminum. A method for electrical power generation using a fuel cell is also disclosed.

U.S. Pat. RE 39,720 discloses an apparatus for treating an exhaust gas stream from cold startup through continuous operating conditions of an internal combustion engine includes an oxidizing catalyst bed disposed in an exhaust pipe and a reducing catalyst bed disposed in the exhaust pipe downstream from the oxidizing catalyst bed. The oxidizing catalyst bed as one or more oxidizing catalysts and the reducing catalyst bed has one or more reducing catalysts. A method is provided for treating an exhaust gas stream both during cold start and during continuous operating conditions of an internal combustion engine by passing the stream through an oxidizing catalyst bed having one or more oxidizing catalysts at a light off temperature; a reducing catalyst bed having one or more reducing catalysts and providing hydrogen into the reducing catalyst bed to condition the reducing catalyst; and introducing hydrogen into the internal combustion engine during cold startup.

U.S. Pat. No. 7,357,912 discloses a method of catalytically decomposing water, which includes contacting water with a composite catalyst including a solid acid catalyst and a solid base catalyst at an elevated temperature, wherein the composite catalyst contains the solid acid catalyst in an amount of 36 to 65% by weight and the balance being the solid base catalyst, and wherein the temperature is higher than a temperature at which pH values of the (H₂O/O₂ redox) potential and (H₂O/H₂ redox) potential are equal to each other, the redox potentials being given by a water potential-pH value diagram.

The U.S. Pat. No. 7,393,440 provides a system for generating hydrogen gas in an aqueous solution based electrolytic or galvanic cell wherein the cathode is made from aluminum or an aluminum alloy. In a preferred arrangement the cell is a galvanic cell and cathode is made from aluminum or aluminum alloy and the anode is made from magnesium or magnesium alloy

An internal combustion engine is powered by an apparatus which produces hydrogen fuel from water. Such an apparatus is disclosed in U.S. Pat. No. 7,475,656 and includes water supply means; fuel storage means; controlling means; a collector, receiving combustion products output from engine's operation; a transformer, utilizing thermo-impact of the combustion products and converting supplied water into ionized hydrogen and oxygen. An ion divider is provided which electrically separates hydrogen and oxygen ions into gaseous hydrogen, being further directed into the fuel storage means and controllably fed substantially into engine's cylinders. Exhaust means output exhaust products from the collector into the atmosphere and on their way out heating water in the water supply means. The fuel storage means contain initial hydrogen or another predetermined fuel. Electrolyzer means are provided to supplement hydrogen and oxygen ions production.

U.S. Pat. No. 7,507,489 discloses a Solid electrolytic Fuel Cell (SOFC) being small in size and large in output while providing enough efficiency and being excellent in starting characteristics and load variation characteristics. A honeycomb type solid-oxide fuel cell is formed of a honeycomb structural body having square cell in cross section. Cells adjacent to wall surfaces constituting a fuel pole cell and function as air pole cells. Cells adjacent to the corners of wall surfaces of the fuel pole cell and adjacent to wall surfaces constituting air pole cell and function as cooling air cells, whereby fuel pole cells, air pole cells and cooling air cells are arranged in longitudinal and lateral rows so that cells of the same type appear in every other location.

U.S. Pat. No. 7,510,633 discloses an electrolyzer cell for the electrolysis of water includes a cathode of generally tubular configuration within which is disposed an anode separated from the cathode by a separation membrane of generally tubular configuration which divides the electrolyte chamber into an anode sub-chamber and a cathode sub-chamber. An electrolyzer apparatus includes an array of individual cells across each of which an electric potential is imposed by a DC generator via electrical leads. Hydrogen gas generated within cells from electrolyte is removed via hydrogen gas take-off lines and hydrogen manifold line. By-product oxygen is removed from cells by oxygen gas take-off lines and oxygen manifold line. The electrolyzer apparatus may be configured to operate either batchwise or in a continuous electrolyte recycle operation to produce high purity hydrogen at high pressure, e.g., up to about (10,000) psig, without need for gas compressors to compress product hydrogen.

U.S. Pat. No. 7,520,916 discloses a method of operating a fuel cell system, The method includes providing a fuel inlet stream into a fuel cell stack, operating the fuel cell stack to generate electricity and a hydrogen containing fuel exhaust stream, separating at least a portion of hydrogen contained in the fuel exhaust stream using partial pressure swing adsorption, and providing the hydrogen separated from the fuel exhaust stream to a hydrogen storage vessel or to a hydrogen using device.

Emissions from systems that use a catalytic converter are substantially reduced by introducing hydrogen, or a hydrogen containing fluid or fuel component, into the exhaust stream being scrubbed by the catalytic converter, resulting in instant lightoff and a significant reduction in emissions. This system is disclosed in U.S. Pat. No. 7,523,607. Hydrogen for injection into the exhaust stream may, optionally, be generated within the vehicle using heat recovered from the catalytic converter, and/or the engine or elsewhere in the exhaust system, by a thermoelectric generator, the electrical output of which may be used to perform electrolysis and/or to power a reformer in order to generate the hydrogen. The thermoelectric generator may be retrofit onto the catalytic converter, or integrated in a way that enhances thermoelectric generation, including providing a catalyst coated heat sink and integrated cooling pipes to enhance the thermal differential required for thermoelectric generation. Sensors such as an oxygen sensor and temperature sensor may be provided to assess converter performance and adjust the temperature differential to ensure that the temperature of the converter remains optimum.

U.S. Pat. No. 7,524,342 discloses a hydrogen gas generation system for vehicles and stationary power applications. The system includes a trio of rigid, cylindrical high pressure reservoir tanks interconnected with suitable fittings and pipelines. A water holding tank alternatively stores hydroxide solution, or transfers it to an adjacent gas generating tank, containing a plurality of tubular, aluminum fuel rods. When the holding tank is suitably pressurized, hydroxide solution is transferred into the generating tank to start a reaction with a plurality of elongated, tubular aluminum rods disposed therewithin. Conversely, the liquid contents of the generating tank can be forcibly pressured back into the holding tank to stop the gas generation reaction. High pressure hydrogen gas is humidified in the third tank prior to combustion as fuel. Humidified hydrogen is transferred via control valves to the application.

US-Patent Application 2009/078568 relates to an on-demand hydrogen gas generation device, suitable for use in a fuel cell, which utilizes water electrolysis, and more particularly galvanic cell corrosion, and/or a chemical hydride reaction, to produce hydrogen gas. The present disclosure additionally relates to such a device that includes a switching mechanism that has an electrical current passing therethrough and that repeatedly and reversibly moves between a first position and a second position when exposed to pressure differential resulting from hydrogen gas generation, in order to alter the rate at which hydrogen gas is generated, such that hydrogen gas is generated on an as-needed basis for a fuel cell connected thereto, and/or ensure a substantially constant flow of hydrogen gas is released therefrom. The present disclosure additionally or alternatively relates to such an on-demand hydrogen gas generation device that includes a gas management system designed to maximize the release or evolution of hydrogen gas, and in particular dry hydrogen gas, therefrom once it has been formed, thus maximizing hydrogen gas output. The present disclosure is still further directed to a fuel cell including such an on-demand hydrogen gas generation device, and in particular a fuel cell designed for small-scale applications.

The international patent Application WO 2008/154721 discloses a process encompassing hydrogen and oxygen gases as a partial fuel source when utilized together with a fossil-based fuel to power conventional internal combustion engines. Hydrogen and oxygen gases are produced by electrolysis in an electrolyser unit(s), on-demand and on-board a vehicle, or in stationary applications, eliminating the need of highly-pressurized hydrogen storage tanks. When said gases are introduced into the combustion chamber of the engine, via the air intake assembly, they increase the efficiency of the combustion burn by enriching the air to fuel ratio, resulting in a reduction of the fossil-based fuels required for optimum engine performance, said gases effectively becoming a partial hybrid fuel source. The process includes scalability for all size and types of installations, cold-weather applications and longer operating capabilities. As an additional benefit, in direct correlation, this process reduces carbon dioxide emissions, and, in varying quantities, other greenhouse gas emissions.

U.S. Pat. No. 7,108,229 discloses an arrangement and a method for the generation of water on board an aircraft with the use of one or more fuel cells, whereby low-temperature fuel cells are provided. It is proposed that several single-cell or few-cell fuel cells may form a fuel-cell panel or cell array and several cell panels or cell arrays may be arranged close to the inside of the aircraft fuselage and the cathode side of the at least one fuel cell has a chamber pointing to the exterior of the aircraft for the condensation of the water contained in the air and the anode side has a chamber carrying a combustion gas, for example hydrogen. With the proposed solution, a reduction in the storage capacity for drinking water and its quality-assured provision may be enabled and moreover, with the use of fuel cells as a virtual power station, the energy demand on engine generators, auxiliary power unit (APU) or ram air turbine (RAT) may be reduced

U.S. Pat. No. 5,143,025 discloses a water to fuel production apparatus including a tank divided into compartments for producing hydrogen in one compartment and oxygen in another compartment, where the gases produced do not contact each other in the compartments or until they are mixed prior to entering an internal combustion engine. Additionally, a control system is provided, including cathodes and anodes in the compartments and a switching system to turn individual cathodes and anodes on or off.

### SUMMARY OF THE INVENTION

An object of the present invention is to provide a system for providing hydrogen on demand to an internal combustion engine by electrolysis from water at rate according to the actual required power of an internal combustion engine an without the need to store hydrogen.

The present invention provides a system for providing hydrogen to an internal combustion engine which is surrounded by a body including:

an on demand hydrogen production unit for producing hydrogen and oxygen from water by electrolysis;

a relay, wherein the relay has a connection to an electric generator, a relay-triggered connection to the system for providing hydrogen and a connection to the ground potential defined by the body;

a switchable electric circuit, for providing power to the on demand hydrogen production unit;

a fuse in the relay-triggered connection between the relay and the electrolysis device for producing hydrogen and oxygen; and

a first duct from the electrolysis device, transporting oxygen, is connected directly to the environment and a second duct from the on demand hydrogen production unit, transporting hydrogen, is connected directly with the internal combustion engine.

The switchable electric circuit is the ignition circuit of the internal combustion engine. A fuse is part of the system and is preferably a 80 amp fuse.

The on demand hydrogen production unit defines a first portion for holding a plurality of parallel and plate like anodes and a second portion for holding a plurality of parallel and plate like cathodes. A cover of the on demand hydrogen production unit for the first portion has an outlet and an attached duct for oxygen. The duct for oxygen leads to the environment. The cover of the on demand hydrogen production unit for the second portion has an outlet and an attached duct for hydrogen. The duct for hydrogen leads to an internal combustion engine. Additionally, an intake is mounted to the container for providing water from a reservoir, so that the level of water is maintained at a constant level within the container.

According one embodiment the first portion and the second portion of the container of the on demand hydrogen production unit have a cuboidal design. A dividing wall is between the first portion and the second portion of the container. The dividing wall is designed such that there is a water communication between the first portion and the second portion. The plurality of parallel and plate like anodes and cathodes has an essentially rectangular shape.

All the parallel and plate like anodes are connected in an electrical conductive way and all the parallel and plate like cathodes are connected in an electrical conductive way.

A further embodiment of the present invention is that the first portion and the second portion are tubes of a circular or elliptical cross-section. A fluid communication is provided between the first portion and the second portion. The fluid communication between the first portion and the second portion is made of an U-shaped tube element. The first portion and the second portion of the on demand hydrogen production unit have a circular or elliptical cross-section and the plurality of parallel and plate like anodes and cathodes are tubes with circular or elliptical cross-section. The surfaces of the circular or elliptical tubes are parallel.

The plate like anodes and the cathodes are made from electrically conductive material which is surface treated in order to provide a smooth and clean surface. The gas bubbles produced during the electrolysis do not stick to the surface of the plates for the plates. The plates are made from steel, stainless steel, aluminum, palladium or titanium.

It is preferred that the energy user is an internal combustion engine. A switchable electric circuit of the system, into which the on demand hydrogen production unit for providing hydrogen to an internal combustion engine, is connected to the ignition circuit of the internal combustion engine. For safety reasons the fuse is a 80 amp fuse.

The on demand hydrogen production unit defines a first portion for holding a plurality of parallel and plate like anodes and a second portion for holding a plurality of parallel and plate like cathodes. A cover is provided for the first portion wherein the cover has an outlet and an attached duct for oxygen, wherein the duct for oxygen leads to the environment. A cover is provided for the second portion with an outlet and an attached duct for hydrogen, wherein the duct for hydrogen leads to the internal combustion engine. An intake to the container provides water from a reservoir, so that the level of water is maintained at a constant level within the container.

In a preferred embodiment the cathode side of the electrolysis device has a duct for H₂-gas and the duct ends in the water reservoir.

The method is advantageous because the hydrogen produced from water by electrolysis with an on demand hydrogen production unit is delivered to the energy user and not delivered to a storage device for hydrogen. In case the energy user is an internal combustion engine the hydrogen produced by the on board electrolysis device is delivered only to the internal combustion engine. No storage is required. The production of hydrogen by the on board electrolysis device stops if no hydrogen is required by energy user or the internal combustion engine.

In case the on demand hydrogen production unit is integrated in a car or truck the battery provides 12 Volts DC (direct current) and the same voltage is applied to the electrolysis device. The application of at 15-30 amps produces one liter of hydrogen in 2-3 seconds. In case an increased amount of hydrogen is required an increased current is applied to the electrolysis device. Another possibility is that multiple electrolysis devices are used in parallel connection in order to produce enough hydrogen for internal combustion engine. The maximum voltage is between 12 to 24 volts DC (direct current). The maximum current (amperage) ranges from 15 to 30 amps. The current applied to electrolysis device changes with the load required by the internal combustion engine. The effective surface area of the plates within each portion or the electrolysis device is 1 foot by one foot. With this dimension the production of one liter hydrogen in 2-3 seconds is achieved at 12 volts DC (direct current) with a current at 15-30 amps. The effective surface is the surface of the plate if all the plates of on portion of the electrolysis device are stretched out in one plane.

The plates are of electrically conductive material. Preferably the material is steel stainless steel, aluminum, palladium or titanium. The surface of the plates is treated so that the adhesion of the gas bubbles to the plates, produced during the electrolysis process, is reduced. The surface finishing step cleans the surface of the plates and provided a smooth and regular finish to the plates. The surface treatment causes a faster the release of hydrogen which in turn increases the amount of H₂-gas generated by the electrolysis process. The most important issue for the production of hydrogen is the release of the gas bubbles from the surface of the plates. The release of the gas bubbles keeps the current flow across the matrix of the plate system. The surface treatment of the plates is done chemically and the surface treatment process is an etching process.

The preferred design of the electrolysis device the U-shaped form. The electrolysis device is basically a U-shaped pipe with end caps. The end caps house the plate configuration as well as the water fittings.

At temperatures below freezing an anti freeze agent can be added to the water reservoir/and or the electrolysis device.

### BRIEF DESCRIPTION OF THE DRAWINGS

Exemplary embodiments will describe the apparatus for economically forming packing unit layers according to the present invention in more detail and its advantages with reference to the accompanying drawings, in which:

FIG. 1 is a schematic perspective view of one embodiment of an on demand hydrogen production unit for water electrolysis and de production of hydrogen for an internal combustion engine.

FIG. 2 is a schematic top view of the embodiment shown in FIG. 1.

FIG. 3 is a perspective top view of another embodiment of an on demand hydrogen production unit for water electrolysis and the production of hydrogen for an internal combustion engine.

FIG. 4 is a schematic side view of the embodiment shown in FIG. 3.

FIG. 5 is a schematic arrangement of on demand hydrogen production unit in combination with an internal combustion engine.

FIG. 6 is a schematic diagram of the implementation of the on demand hydrogen production unit for water electrolysis in a car.

FIG. 7 is a schematic diagram of the mechanical implementation of the on demand hydrogen production unit for water electrolysis in a car.

### DETAILED DESCRIPTION

Identical reference numerals are used for the same or equivalent elements of the invention. Furthermore, only reference numerals are shown in the drawings which are necessary for the description of each figure for clarity. It is clear fro any skilled person that the present invention is not limited to land vehicles, like cars, trucks, ships etc. The invention can be used in all applications of internal combustion engines.

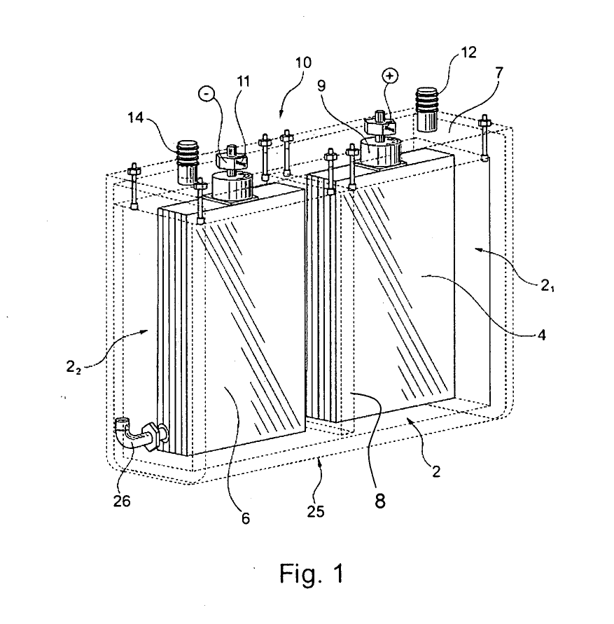

FIG. 1 schematically shows perspective view of one embodiment of an on demand hydrogen production unit 10 for water electrolysis and the production of hydrogen for an energy user which is an internal combustion engine. The on demand hydrogen production unit 10 has a container 2 which defines a first portion 2₁ for holding a plurality of parallel and plate like anodes 4 and a second portion 2₂ for holding a plurality of parallel and plate like cathodes 6. The first portion 2₁ and the second portion 2₂ are separated by a dividing wall 8 which nevertheless provides a fluid communication between the first portion 2₁ and the second portion 2₂. A cover 7 for the first portion 2₁ and the second portion 2₂ is provided. The cover 7 can be designed as well in a two part form, wherein a first cover closes the first portion 2₁ and a second cover closes the second portion 2₂ of the on demand hydrogen production unit 10.

The first portion 2₁ houses the plate like anodes 4 and the cover 7 carries an electrical connection 9. The second portion 2₂ houses the plate like cathodes 6 and the cover 7 carries an electrical connection 11. In addition the cover 7 has formed an adapter 12 for a duct above the first portion 2₁, wherein the duct transports the oxygen molecules from the first portion 2₁ and to the environment. Additionally, an adapter 14 for a duct is provided above the second portion 2₁, wherein the duct transports the hydrogen molecules from the second portion 2₁ to the internal combustion engine or energy user.

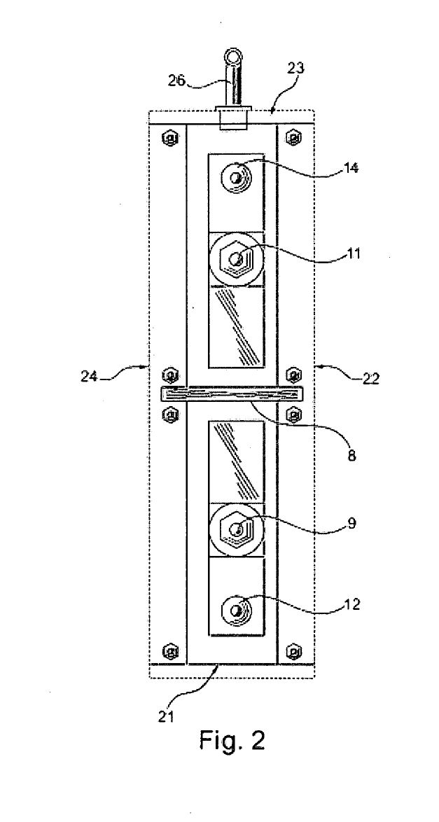

In the embodiment shown in FIGS. 1 and 2 the container 2 is formed by a plurality of side walls 21, 22, 23 and 24 and one bottom wall 25. One of the side walls 21, 22, 23, or 24 has an intake 26 for providing water from a reservoir, so that the water level is maintained at a constant level within the container 2.

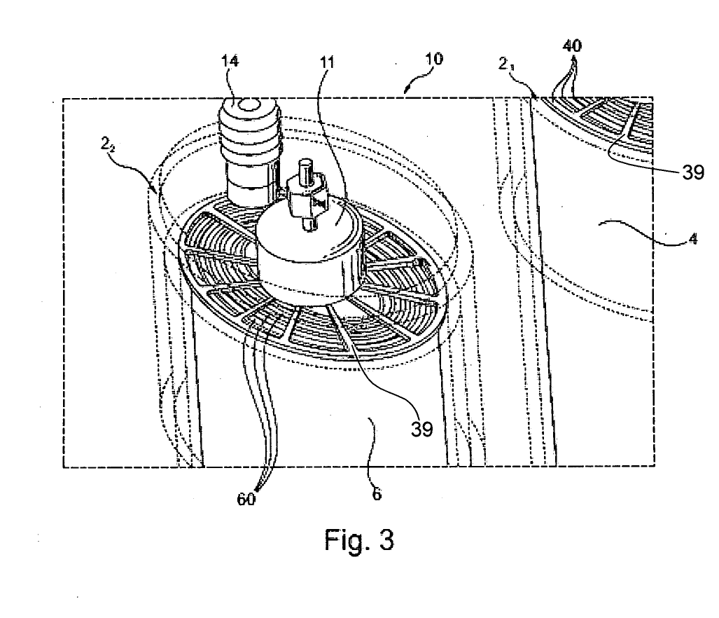

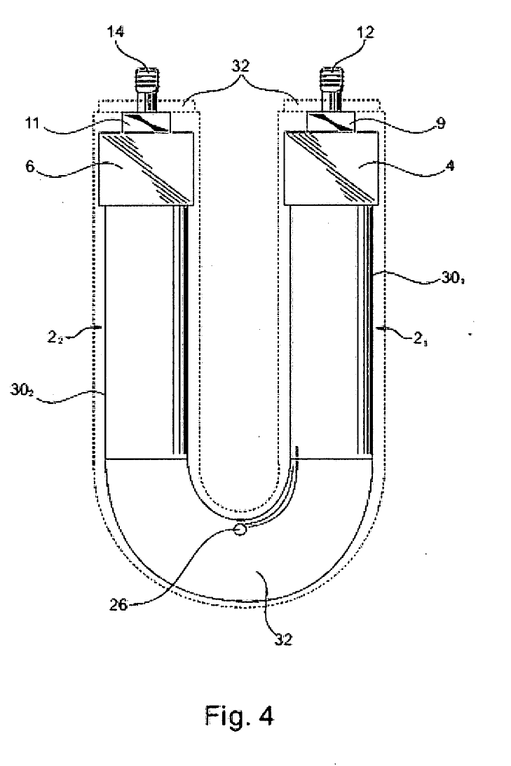

FIG. 3 and FIG. 4 show a further embodiment of the on demand hydrogen production unit 10. The on demand hydrogen production unit 10 is designed in a U-shaped form. The U-shaped on demand hydrogen production unit 10 has a first arm 30₁ which defines the first portion 2₁ for holding a plurality of parallel and plate like anodes 4. A second arm 30₂ of the U-shaped on demand hydrogen production unit 10 defines the second portion 2₂ for holding a plurality of parallel and plate like cathodes 6. The first portion 2₁ and the second portion 2₂ are connected via an U-shaped bend 32 which provides fluid connection between the first portion 2₁ and the second portion 2₂. The U-shaped bend 32 can be in the form of an U-shaped tube which connects the first portion 2₁ and the second portion 2₂ of the on demand hydrogen production unit 10. In order to limit the water in the on demand hydrogen production unit 10 the U-shaped bend 32 can have any other form which is required to reduce the volume of the U-shaped bend 32. The first portion 2₁ and the second portion 2₂ as close together as possible.

FIG. 3 shows a detailed an enlarged view of the top portion of the on demand hydrogen production unit 10. The second portion 2₂ is displayed in greater detail. The first portion 2₁ and the second portion 2₂ have an elliptical cross-section. It is self-evident for a skilled person that the shape of the cross-section of the first portion 2₁ and the second portion 2₂ can be circular as well. The shape shown in FIG. 3 should not be regarded as a limit of the scope of the present invention. In the embodiment shown in FIG. 3 the anode plates and the cathode plates are concentrically arranged. Each of the circular or elliptical anode plates 40 or cathode plates 60 have an outer and an inner surface which are parallel to each other. The anode plates 40 are electrically connected via a connector 39. The cathode plates 60 are electrically connected via a connector 39

The first arm 30₁ is closed with a cover 32 and the second arm 30₂ is closed as well with a cover 32. The cover on the first arm 30₁ carries an adapter 12 for a duct. Additionally, the cover on the second arm 30₂ carries as well an adapter 14 for a duct. The cover 32 on the first arm 30₁ carries the electrical connection 9 for the anodes 4 and the cover 32 on the second arm 30₂ carries the electrical connection 11 for the cathodes 6. The anode and cathode plates are surface treated in order to allow sufficient and effective production of hydrogen with the electrolysis device 10. As shown in FIG. 4 an inlet 26 to the container is provided. Water from a reservoir 42 is guided to the on demand hydrogen production unit 10, so that the level of water is maintained at a constant level within the container and the on demand hydrogen production unit 10 respectively.

In both embodiments of the container 2 the rectangular shaped electrolysis device 10 and the U-shaped electrolysis device 10 and the covers thereof are made from a polymer. The polymer is a duroplast and preferable it is polycarbonate.

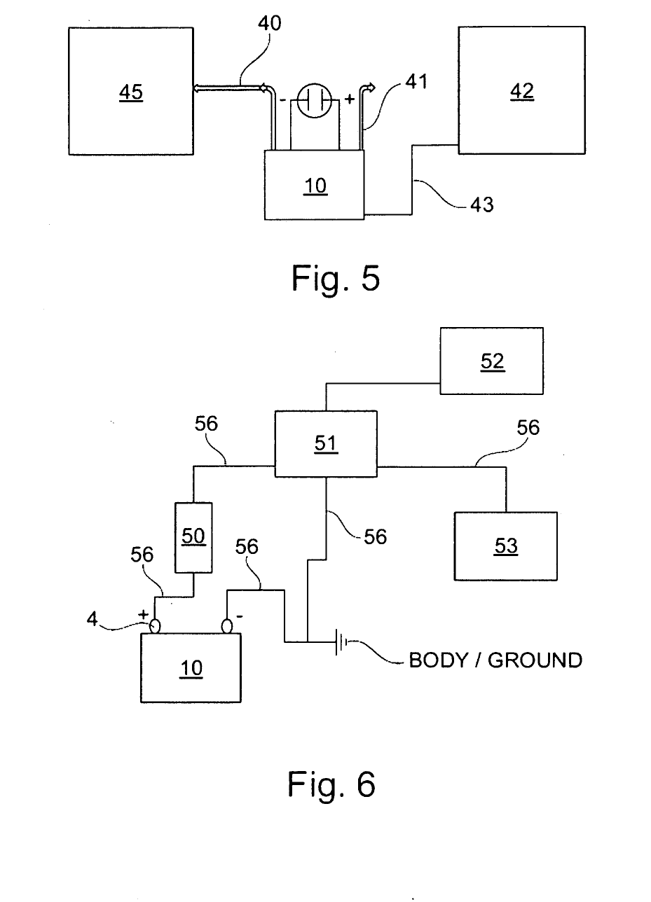

FIG. 5 is a schematic arrangement of on demand hydrogen production unit 10 in combination with an internal combustion engine 45. The on demand hydrogen production unit 10 is provided with additional water via a duct 43 from a reservoir 42. The mounting of the duct 43 to the on demand hydrogen production unit 10 is already mentioned in the description to FIG. 1 and FIG. 2. A special voltage and a special current are applied to the on demand hydrogen production unit 10 in order to produce hydrogen and oxygen from water. A duct 41 is mounted to the anode side of the on demand hydrogen production unit 10. The duct 41 transports the produced oxygen to the environment. A duct 40 is mounted to the anode side of the on demand hydrogen production unit 10 wherein the duct 40 transports the hydrogen gas from the on demand hydrogen production unit 10 to the internal combustion engine 45.

FIG. 6 is a schematic diagram of the implementation of the on demand hydrogen production unit 10 for water electrolysis in a car. For the implementation of an on demand hydrogen production unit 10 in a car it is necessary to provide electrical cables 56 with sufficient cross-section in order to transport the required current. In order to enable sufficient production of hydrogen for an internal combustion engine 45 of a car, the cables 56 should be designed for a current of maximal 15 to 30 amps. The on demand hydrogen production unit 10 is connected to a switchable electric circuit 52, which could be the ignition circuit of the internal combustion engine 45. The switchable electric circuit 52 is connected to a relay 51. The relay 51 has a connection to an electric generator 53, a relay-triggered connection to the on demand hydrogen production unit 10 for providing hydrogen and a connection to the ground potential defined by the body of the car. Between the anode 4 of the on demand hydrogen production unit 10 the relay 51 a fuse 50 is provided. The fuse is a 80 amp fuse. The electric connection to the electrolysis device 10 can be established as well from the windshield wiper circuit. The on demand hydrogen production unit 10 can be provided as well via an own switchable electric circuit with the required electric power.

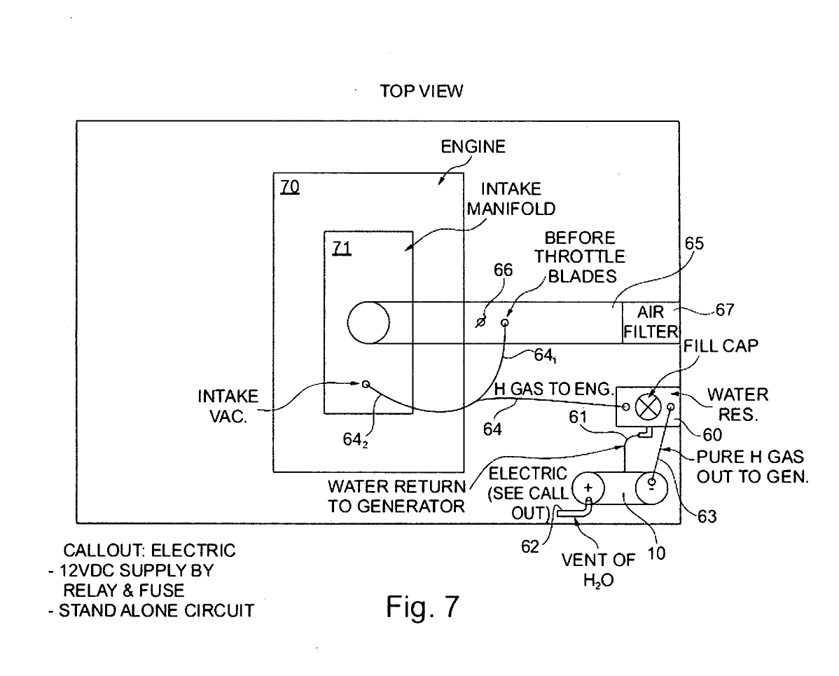

FIG. 7 schematically shows the mechanical implementation of the on demand hydrogen production unit 10 for water electrolysis in a car. The on demand hydrogen production unit 10 is of U-shaped form. A water reservoir 60 is connected via a return duct 61 with the electrolysis device 10. From the water reservoir 60 the electrolysis device 10 is provided with water in order to keep a constant water level in the on demand hydrogen production unit 10. The anode side of the on demand hydrogen production unit 10 has a vent 62 for O₂-gas. The cathode side of the on demand hydrogen production unit 10 has a duct 63 for H₂-gas and the duct 63 ends in the water reservoir 60. From the water reservoir 60 a supply duct 64 for H₂-gas is split up in a first supply duct portion 64₁ and a second supply duct portion 64₂.

The reason for the provision of the H₂-gas to the water reservoir 60 is to keep up a certain pressure of the H₂-gas and to make sure the water is supplied from the water reservoir 60 to the on demand hydrogen production unit 10. Additionally, pressure of the H₂-gas in the water reservoir 60 ensures the supply to the H₂-gas to the engine 70. The water reservoir 60 keeps a certain amount of H₂-gas which facilitates a constant flow of H₂-gas during the starting process of the internal combustion engine of the vehicle. Additionally, the H₂-gas which comes from the on demand hydrogen production unit 10 carries some humidity and the within the water reservoir the H₂-gas is cleaned from the humidity. Even if the description according to FIG. 7 talks about a car this should not be regarding as a limitation of the invention.

The first supply duct portion 64₁ ends at an air intake canal 65 prior to the throttle blades 66. The air intake canal 65 is covered with an air filter 67 and the opposite end of the air filter ends at the intake manifold 71 of the engine 70. The second supply duct portion 64₂ ends at the intake manifold 71.

Control of the system is provided in the form of an electric circuit. The electric circuit can be the electric circuit of the car or the vehicle and the energy supply is via 12 volts direct current and by a relay and fuse. The electric circuit can be configured as well in the form of a stand alone circuit.

The invention has been described with reference to a preferred embodiment. It goes without saying for a person skilled in the art that changes and modifications can be made without leaving the scope of protection of the dependent claims. The present invention can be used with all applications which use an internal combustion engine. The invention is not limited to land vehicles, like cars, trucks, ships etc.

What is claimed is:

1. A system for on demand hydrogen production and delivery of hydrogen to an internal combustion engine which is surrounded by a body comprising:
an on demand hydrogen production unit for producing hydrogen and oxygen from water by electrolysis;
a relay, wherein the relay has a connection to an electric generator, a relay-triggered connection to the system for providing hydrogen and a connection to the ground potential defined by the body;
a switchable electric circuit for providing power to the on demand hydrogen production unit;
a fuse in the relay-triggered connection between the relay and the on demand hydrogen production unit for producing hydrogen and oxygen; and
a first duct from the demand hydrogen production unit, transporting oxygen, being connected directly to an environment of the system and a second duct from the on demand hydrogen production unit, transporting hydrogen, being connected directly with the internal combustion engine.

2. System as defined in claim 1, wherein the switchable electric circuit is the ignition circuit of the internal combustion engine.

3. System as defined in claim 1, wherein the fuse is an 80 amp fuse.

4. System as defined in claim 1, wherein the on demand hydrogen production unit defines a first portion for holding a plurality of parallel and plate like anodes and a second portion for holding a plurality of parallel and plate like cathodes; a cover for the first portion with an outlet and an attached duct for oxygen, wherein the duct for oxygen leads to the environment; a second portion cover for the second portion with a second portion outlet and an attached second portion duct for hydrogen, wherein the second portion duct for hydrogen leads to an internal combustion engine; and an intake to the container for providing water from a reservoir, so that a level of water is maintained at a constant level within the container.

5. System as defined in claim 4, wherein the first portion and the second portion for of the container of the on demand hydrogen production unit is of cuboidal design.

6. System as defined in claim 4, wherein a dividing wall between the first portion and the second portion of the container is designed such that there is a water communication between the first portion and the second portion.

7. System as defined in claim 4, wherein the plurality of parallel and plate like anodes and cathodes has a rectangular shape.

8. System as defined in claim 7, wherein all the parallel and plate like anodes are connected in an electrical conductive way and all the parallel and plate like cathodes are connected in an electrical conductive way.

9. System as defined in claim 4, wherein the first portion and the second portion are tubes of a circular or elliptical cross-section and a fluid communication is provided between the first portion and the second portion.

10. System as defined in claim 9, wherein the fluid communication between the first portion and the second portion is made of a U-shaped tube.

11. System as defined in claim 9, wherein the plurality of parallel and plate like anodes and cathodes are tubes with circular or elliptical cross-section and wherein the surfaces of the circular or elliptical tubes are parallel.

12. System as defined in claim 1 wherein the plate like anodes and the cathodes are made from electrically conductive material which is surface treated in order to provide a smooth and clean surface for the plates so that gas bubbles produced during the electrolysis do not stick to the surface of the plates.

13. System as defined in claim 1, wherein the plates are made from steel stainless steel, aluminum, palladium or titanium.

14. System as defined in claim 13 wherein the cathode side of the on demand hydrogen production unit has a duct for H₂-gas and the duct ends in the water reservoir.

15. System as defined in claim 14 wherein a duct leads from the water reservoir to an air intake canal of the internal combustion engine.
